(19) United States
(12) Patent Application Publication
(10) Pub. No.: US 2006/0200374 A1
(43) Pub. Date: Sep. 7, 2006

(54) Automatic scheduling method and apparatus

(76) Inventor: Yoram Nelken, San Francisco, CA (US)

Correspondence Address: Martin D. Moynihan;PRTSI, Inc., P.O. Box 16446, Arlington, VA, 22215, US

(21) Appl. No.: 11/364,168

(22) Filed: Mar. 1, 2006

Related U.S. Application Data
(60) Provisional application No. 60/657,563, filed on Mar. 1, 2005.

(51) Int. Cl. G06F 15/02

(52) U.S. Cl. 705/9

(57) ABSTRACT

An automated method of scheduling activities between users having on-line calendar information available to a network, comprises: electronically reading respective on-line calendar information across said network, the respective calendar information being of a plurality of users intended for a planned activity, thereby to find times of mutual availability, and electronically writing to respective on-line calendar information across said network, to reserve a time slot for said planned activity at respective intended users.

### RELATED APPLICATIONS

The present application claims priority from U.S. Provisional Patent Application No. 60/657,563, filed on Mar. 1, 2005, the contents of which are hereby incorporated by reference.

### FIELD AND BACKGROUND OF THE INVENTION

The present invention relates to an automatic scheduling method and apparatus and, more particularly, but not exclusively to such a scheduling method and apparatus which are designed to schedule and manage multi-user events or activities over a network.

In the past, the kinds of people who organized multi-person meetings, activities, conferences etc. had secretarial support staff who would make the necessary arrangements. Today, where the trend is for people to do their own typing using computers, there is less secretarial support, and people tend to schedule more of the meetings themselves. The existing secretaries have more people to support, and could also use help in scheduling activities, as in many cases scheduling tasks occupy large percent of their workload.

Scheduling programs such as Microsoft Outlook™ have therefore stepped into the breach and provide a calendar packaged with an email program. The calendar can be used to schedule meetings and issue invitations to prospective participants, but typically not to negotiate the best time and place for the meeting. It can further track users who have replied and either accepted or rejected the invitation.

In addition, typically within an organization, outlook can be configured to run on a server so that users can share calendars if they wish. Other users within the organization can thus see free and busy times and send invitations accordingly.

Outlook has a companion server product, Microsoft Exchange™, and this sometimes facilitates meeting scheduling through the provision of shared user calendars. However, this approach is of limited use for a number of reasons. First, all users must be on the same Exchange server, a requirement that is very rarely met in real scheduling circumstances. Secondly, sharing of calendars is not sufficient for actually scheduling a meeting, as what is in a single person's calendar to start with has little bearing on whether or not that is the best time to schedule a given activity, especially if the activity involves multiple users.

While many users of outlook have become accustomed to using the free and busy information available in an outlook meeting request for people on a corporate exchange server as described above, many meetings include someone from outside the company. In these cases, meeting requests devolve into an extended game of chase, involving email and telephone tag. Also, for those people who use outlook without a central server, no calendar sharing at all is possible. Furthermore, even when free/busy sharing is possible, the scheduling problem is not resolved, because just because person A is “free” in a specific timeslots, it does not mean he wants to meet with person B. Similarly, just because the calendar shows “busy”, does not imply person A will decline an invitation from person B.

Making calendar data available outside an organization is not a trivial issue. One issue is corporate confidentiality. One often does not want outsiders to know when one is free or busy, and certainly not to be able to see what projects or clients one is devoting one's time to. Any technological solution would have to address corporate confidentiality.

Furthermore, solutions that allow sharing of data amongst numerous people are vulnerable to unwanted multiplication of data, people sending out notifications to large user lists etc, not to mention deliberate spam. Vulnerabilities of this kind need to be addressed as well.

As an additional complication, once the activity is scheduled and confirmed, there could still be events that affect the activity, including invitees who change their mind, new documents or other data which becomes available after the scheduling has occurred etc. There is no simple way to manage those with the current art. While previous systems, such as Timedance, or Zaplet have attempted to solve some the above-mentioned problems, they have not provided more than a partial solution. Timedance, for example, used the World Wide Web and standard “Internet email” to make it possible for people to schedule meetings across organizational boundaries. However, this system lived outside the context of the users' regular email clients. Timedance also fails to make group scheduling really work in a practical way.

There is thus a widely recognized need for, and it would be highly advantageous to have, a scheduling tool devoid of the above limitations.

### SUMMARY OF THE INVENTION

According to one aspect of the present invention there is provided a scheduler for scheduling activities amongst networked users having on-line calendar information, the scheduler comprising:

a network mobile element directable over said network to invitees, said invitees being ones of said networked users invited to a given activity by another networked user being an activity originator, said network mobile element being configured to automatically cause gathering of availability data from respective on-line calendar information of said invitees, and a scheduling element for collating said gathered availability data, thereby to schedule said given activity at a time of high overall availability amongst said invitees.

According to a second aspect of the present invention there is provided a scheduler for coordinating activities between users having on-line calendar information available to a network, the scheduler comprising an autonomous element configured to transfer itself over said network between said users to interact with online calendar information of respective users, thereby to coordinate activities.

According to a third aspect of the present invention there is provided an automated method of scheduling activities between users having on-line calendar information available to a network, comprising:

electronically reading respective on-line calendar information across said network, said respective calendar information being of a plurality of users intended for a planned activity, thereby to find times of mutual availability, and

electronically writing to respective on-line calendar information across said network to reserve at least one time slot for said planned activity at respective intended users.

According to a fourth aspect of the present invention there is provided an electronic mailing system comprising:

a) an email client. and

b) a scheduling function associated with said email client for inserting into emails functionality for carrying out automatic scheduling of activities via a plurality of proposed time slots.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified schematic block diagram illustrating a scheduler according to a first preferred embodiment of the present invention for allowing scheduling between different users;

FIG. 2 shows the scheduler of FIG. 1 in greater detail;

FIG. 3 is a simplified schematic diagram illustrating a client server configuration according to a preferred embodiment of present invention;

FIG. 4 is another simplified schematic diagram illustrating a first peer to peer implementation of a scheduler according to a preferred embodiment of present invention;

FIG. 5 is another simplified schematic diagram illustrating a second peer to peer implementation of a scheduler, according to a preferred embodiment of the present invention;

FIG. 6 is another simplified schematic diagram illustrating an email based implementation of a scheduler according to a preferred embodiment of the present invention, in which individual users send to each other using an invite list of email addresses of the other invitees;

FIG. 7 illustrates a process for scheduling a meeting according to a preferred embodiment of the present invention;

FIGS. 8-17 are simplified flow charts showing in greater detail parts of the process of FIG. 7;

FIG. 18 is a simplified block diagram showing the implementation of FIG. 3 in greater detail;

FIG. 19 is a block diagram showing the implementation of FIG. 5 in greater detail; and

FIGS. 20-31 are screen shots showing exemplary windows of preferred implementations of the present invention.

### DESCRIPTION OF THE PREFERRED EMBODIMENTS

The present embodiments comprise an apparatus and a method for automatic or semi-automatic scheduling using gathering of event specific availability data over a network, while disseminating information about the activity. Preferably tentative time slots are reserved on calendars of one or more invitees, conflicts are resolved in an optimal way and an optimal time slot for holding an activity is selected.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

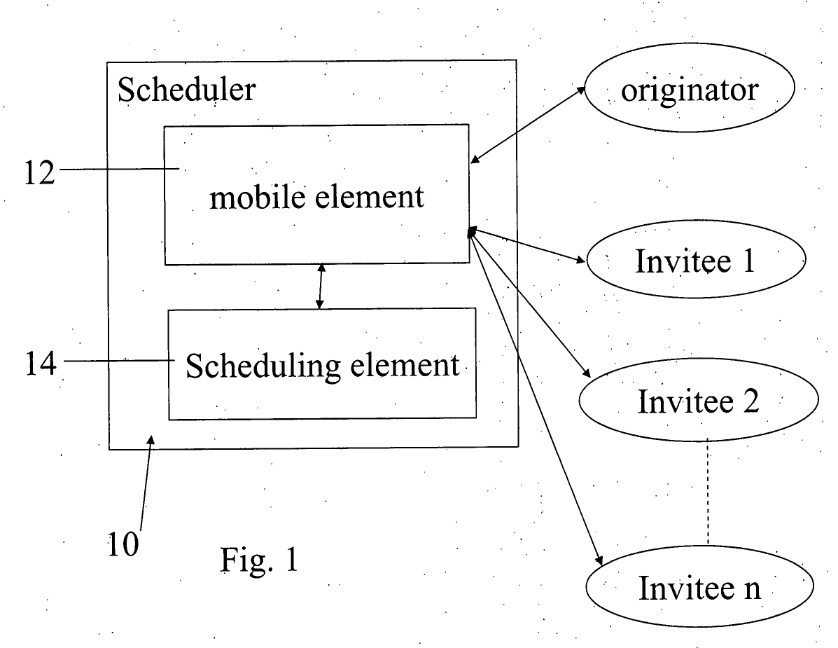

Reference is now made to FIG. 1, which illustrates a scheduler for scheduling activities amongst networked users having on-line calendar information. The scheduler 10 comprises a network mobile element 12 which can be directed over a network between an activity originator and one or more invitees. The network mobile element may be a smart element, that is an element carrying intelligence. Alternatively the necessary intelligence may be located at the various parties, say at a user client, and the network mobile element is simply an activator element and data carrier. The originator is a user of the network who wishes to organize an activity that involves other users and the invitees are the other networked users that the originator intends to invite to the activity. The mobile or smart element 12 automatically or manually gathers availability data from the on-line calendar information of the different invitees, who might be at different locations on a LAN or over the internet or across any other network. Invitees information might be sent automatically, or might require manual intervention on the part of the invitee. The information gathered by the smart element is used by a scheduling element 14. The scheduling element first collates the gathered availability data, and uses the collated information to schedule the activity at a time of high overall availability amongst the invitees. If possible, the scheduler tries to schedule the activity for a time which is free to all invitees. Otherwise, if there is no universally free time the scheduler tries to find a time which is clear or convenient for most of the users (or at least the more important users), and various schemes, as explained in greater detail below, are used to find convenient times.

Typically the smart element enters a tentative reservation in invitees' on-line calendars. If the time is apparently free for all users then the scheduling element sends electronic invitations to each user. The users can then confirm the invitation. The invitees still have the option to reject the invitation. If the invitation is rejected then the process may be repeated. In some of the schemes multiple times can be reserved and invitees vote on the preferred times. This latter scheme is particularly helpful if no time free to everyone can be found.

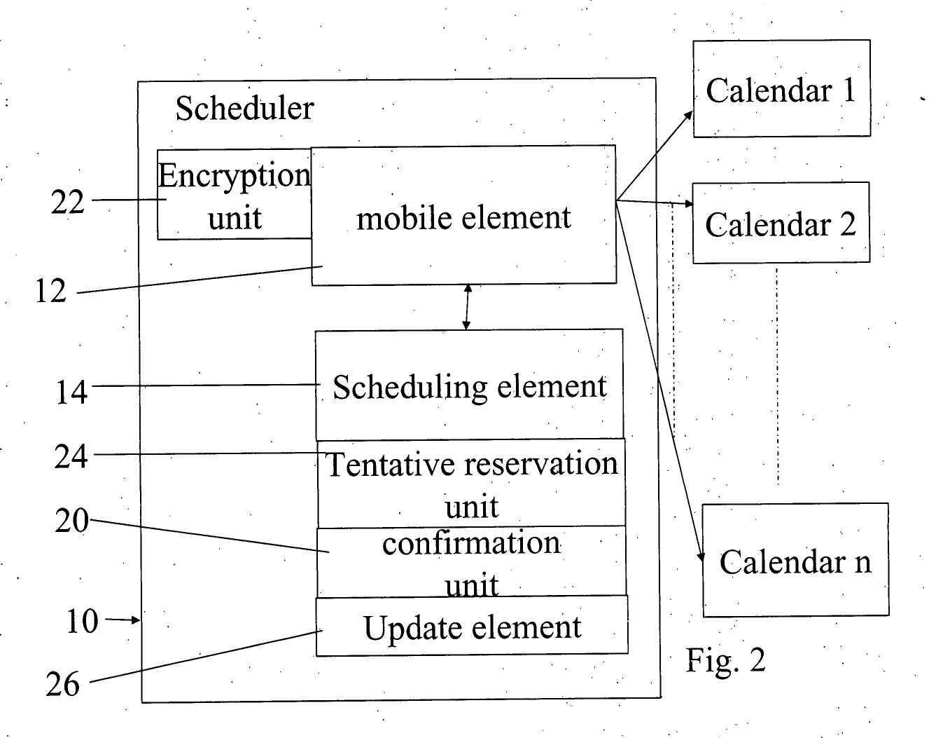

Reference is now made to FIG. 2, which is a simplified diagram showing the scheduler of FIG. 1 in greater detail. Parts that are the same as in FIG. 1 are given the same reference numerals and are not referred to again except as necessary for an understanding of the present figure. The scheduling element includes an invitation unit 20 which issues the electronic invitations referred to above once a suitable time has been found. The confirmation unit 20 typically sends out confirmations by email once a time is confirmed. Aside from email any other suitable protocol may be used. The invitations are preferably similar to those which can be issued today from scheduling programs, in that they include acceptance and rejection options. The acceptance or rejection is automatically emailed back to the scheduling element 14, and if rejections are received then the scheduling element is able to reschedule the activity as necessary. Alternatively, acceptance, rejection and any other support information can be input into a web page specifically generated for this activity.

As described above, all invitees are given equal weight, but not all meetings or activities in practice depend to an equal extent on all users. An option is thus provided to classify invitees, say between essential and non-essential, so that the rescheduling is only carried out following refusal by an essential attendee. In a further embodiment conditions may be applied based on the non-essential attendees as well. Thus a certain number of non-essential attendees could be set, below which the meeting is in any event reset. Alternatively, or additionally, non-essential attendees could be arranged into groups so that at least one member from each group is required to attend. Other rules may be set up by the activity originator as appropriate for his activity.

Similar rules may be set at the earlier stage in which the scheduling element sets a time based on information obtained by the smart element. Rather than setting the meeting for a time at which all invitees are free, the scheduling element may also give weight to the schedules of essential attendees, or consider attendees in groups. In this way the scheduler can seek to maximize the attendance of non-essential attendees without making their attendance a condition for the activity.

The smart element preferably includes an encryption unit 22 to ensure that no sensitive information is sent in plain text form over an open connection.

The smart element itself is typically able to read availability data from the calendars of the various on-line users. One version is compatible with the most common Microsoft Outlook™ scheduler, and other versions include compatibility with other commonly used schedulers.

As mentioned above, the smart element reserves time slots on the invitees' calendars by inserting its own time-slot elements. The time slots could be chosen as suggestions by the meeting originator or could be generated automatically by a tentative reservation unit 24. The reservation unit 24 provides one or more tentative time slots to the smart element, which in turn enters them on the invitees' calendars if the time is free or reports back when the time is not free, as will be described in greater detail below.

The scheduler preferably further includes an update unit 26 whose task is to update the invitees and the originator about the tentatively reserved timeslots. Thus if a timeslot has been accepted by 90% of participants, then the invitees can be informed of this so that they know that the meeting has a high probability of going ahead.

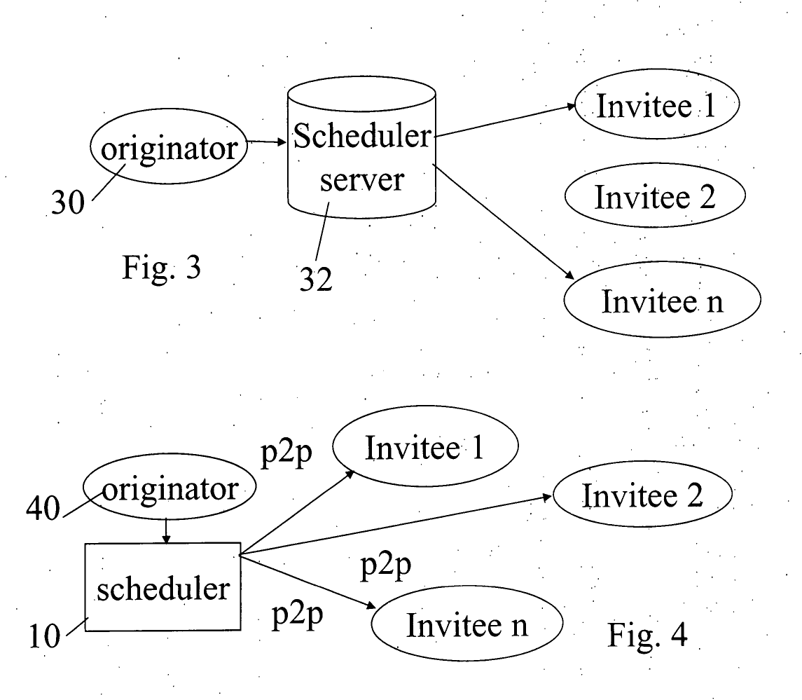

Reference is now made to FIG. 3, which is a simplified diagram showing the scheduler in a client server configuration for remote activation by clients. Organizer 30 connects to server 32 which supports scheduler 10. Scheduler 10 then acts as an intermediary between the organizer and invitees 1 . . . n. The client-server configuration is discussed in greater detail hereinbelow.

Reference is now made to FIG. 4, which is a simplified diagram illustrating a first peer-to-peer configuration of the scheduler. In the arrangement of FIG. 4, the scheduler is located at organizer 40. The smart element 12 communicates which each of the invitees 1 . . . n through direct peer to peer connections with each invitee. It is noted that such a system requires that the organizer and each invitee are on-line simultaneously. The latter condition is likely to be fulfilled where the organizer and the invitees are the kinds of users who have their computers on-line throughout the working day, but may become an issue otherwise.

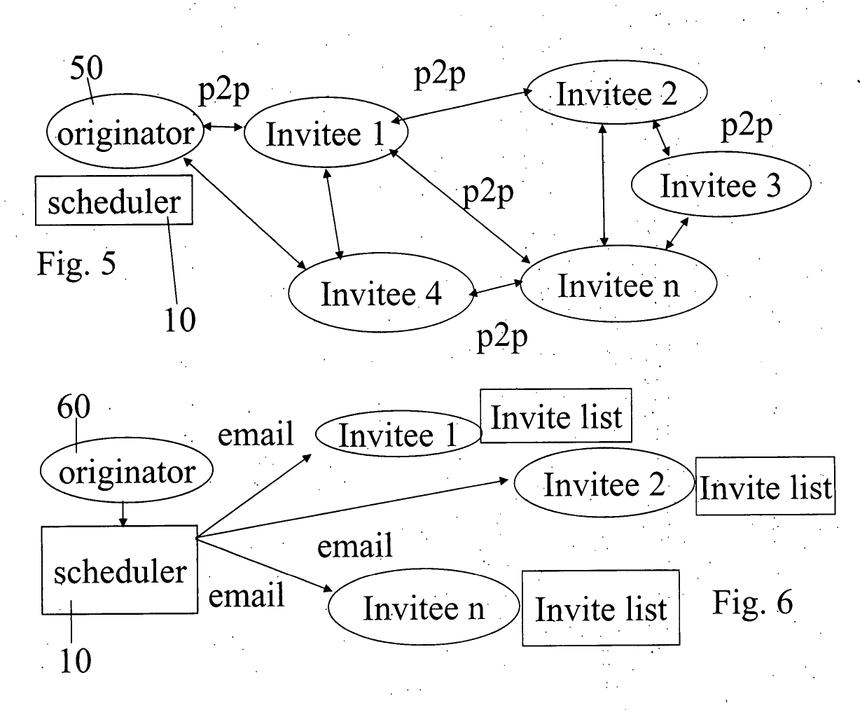

Reference is now made to FIG. 5, which is a simplified diagram illustrating a second peer-to-peer configuration. The second peer to peer configuration is a peer to peer network, in which any node is able to connect to any other node and in which messages are sent along the network on a nearest neighbor basis. Scheduler 10 is located with originator 50 and uses the peer to peer network to send messages to the other invitees. Messages may be relayed from one invitee to another or via other nodes on the network that are not invitees. An advantage of the peer to peer network over direct peer to peer connection is that in the case of the network the originator does not have to be on line simultaneously with each attendee.

Reference is now made to FIG. 6, which is a simplified diagram showing a further configuration of the scheduler. In the configuration of FIG. 6, neither client server nor peer to peer connections are used. Rather the smart element operates through email queries. The scheduler 10 is preferably located with the originator and email queries are sent to each invitee to tentatively reserve timeslots and obtain availability information. Each invitee keeps a list 62 of email addresses of all other invitees and subsequent updating can be sent directly from each invitee to each other invitee and the originator. The embodiment of FIG. 6 has the advantage that no users are required to be on line simultaneously, since email servers store the emails until the particular user connects.

It is noted that different activities may be categorized as important, low level etc. Then during scheduling, an important activity can be given scheduling preference over a less important activity.

As a further enhancement, it is possible to allow an initial meeting invitation to suggest a range in which multiple time slots lie, say “next Thursday” or “two weeks from now”. Scheduling itself works the same way, with all of the time slots in the range initially featuring as tentative timeslots.

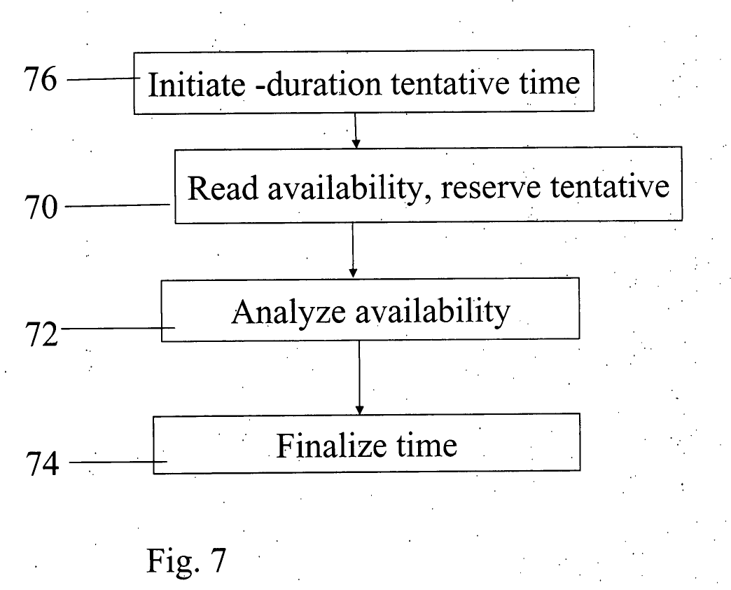

Reference is now made to FIG. 7, which is a simplified flow chart that illustrates an automated method of scheduling activities between users having on-line calendar information available to a network. The method includes three basic stages, a stage 70 which includes electronically reading on-line calendar information of the different invitees across the network. A stage 72 involves analyzing the information to determine times when a maximum number of the invitees are free. Stage 74 involves electronically writing to the calendars of the invitees to reserve the *determined time on the calendars of each of the users. The activity is initiated in stage 76 by the originator, who typically selects the intended duration of the activity and the list of invitees. Certain events may cause step 74 to be looped back to step 76, as will be described in greater detail below.

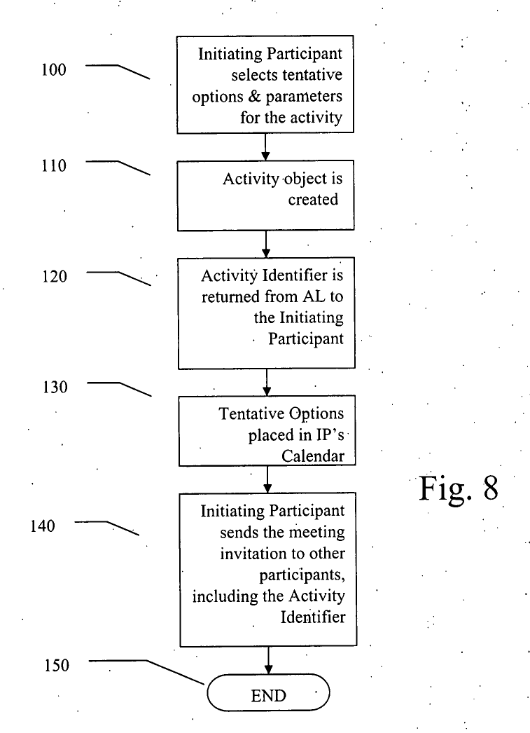

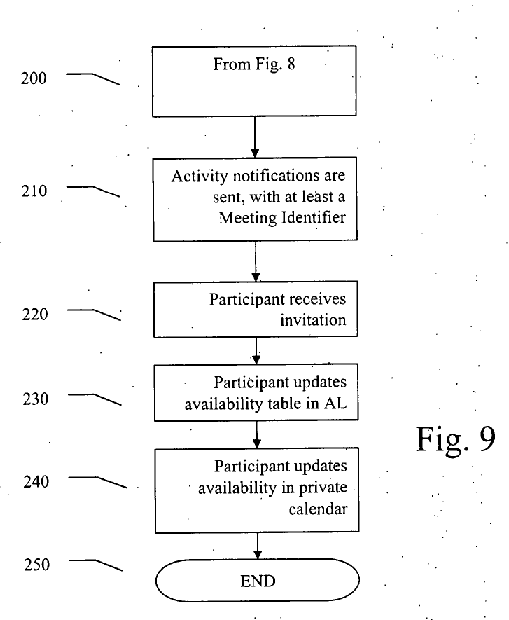

Reference is now made to FIG. 8, which is a flow chart showing the process of arranging an activity amongst multiple users according to a preferred embodiment of the present invention. The present embodiment refers to the server configuration of FIG. 3 and the skilled person will understand how to adjust the scheduler for the other embodiments. In step 100 an initiating participant (Ip), who is the originator 30 referred to above, creates proposed tentative activity data in a network accessible location (A1) at server 32, typically a network accessible database. The database stores the data and allows an activity object to be created, stage 110. The Ip 30 receives an activity identifier in stage 120, and places the data on his calendar in stage 130. The data placed in the Ip's calendar may include just a single time, either initially suggested by the originator or alternatively automatically generated by the tentative reservation unit 24. Alternatively several potentially mutually exclusive options may be reserved. The number of reservations is typically related to the number of invitees or perceived difficulty in finding a suitable time.

If supported by the host calendaring system (e.g. Microsoft outlook™), the data placed in the calendar, here the currently tentative meeting times, is marked as tentative in the calendar, for example using color coding to distinguish it from confirmed activities. In the event that there are multiple invitees, the originator 30 can notify the invitees, using invitations sent as standard text-based email messages or mail messages in stage 140. The invitations may be sent directly from the originator, or indirectly through the server if one is used. The mail messages include an activity identifier which states what the intended activity is.

Tentative activity data also includes one or more preferred times for the activity. Other parameters may be location, subject, notes, “RSVP by” etc.

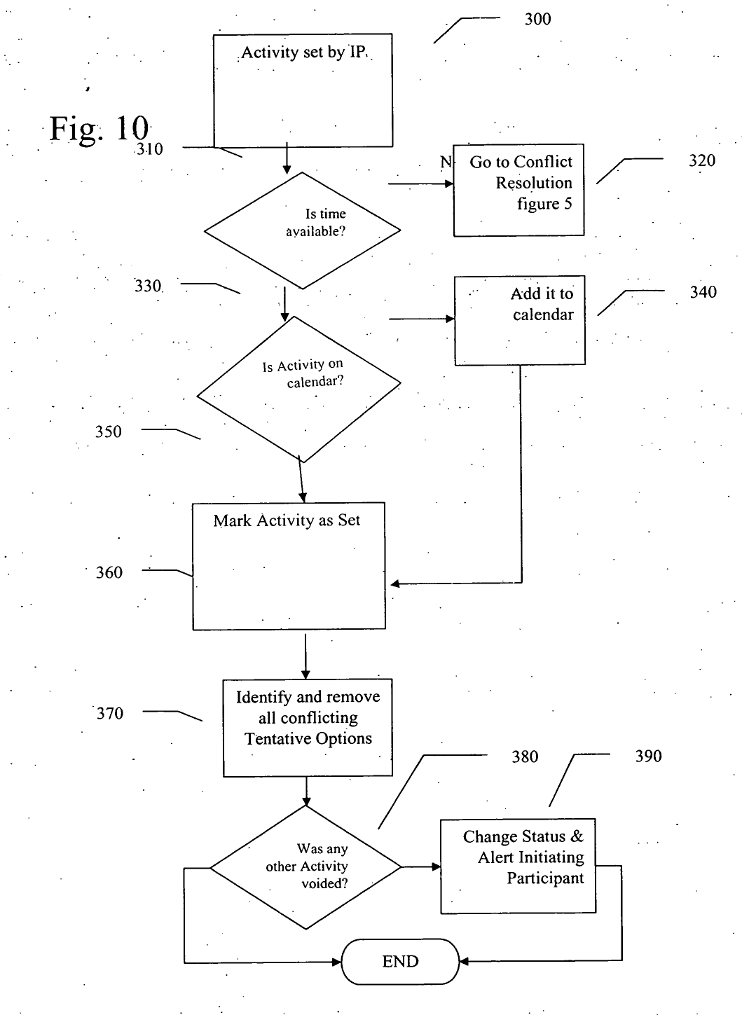

Returning to stage 140 and the activity notifications are sent to users either directly from the initiating participant, or from the web based server as explained. Reference is now made to FIG. 9, which is a continuation of the flow chart of FIG. 8 showing the procedure as it continues at the invitee. The notification is sent in stage 210, and is received by the invitees or participants in stage 220. In stage 230 the participants update their preferences in the Al at server 32, via standard interfaces. In stage 240, which may be carried out before, after or in parallel with, stage 230, the participant updates his availability data on his own calendar. At this point, stage 250, the updating of the Al is completed. An optional temporary message board, update element 26 in FIG. 2, allows participants to exchange information in order to maximize the chances of positive results. In the present case, positive results refer to setting the meeting at a time promising maximum attendance.

The above activities of the participants can be performed automatically. Thus participants can install local software that monitors activity notifications, provided they contain valid activity identifiers, and perform automatic actions such as accept or reject of optional times for the activity based on availability in the calendar, or report changes & events to the server or other users. Other users may prefer to place data in their calendars manually.

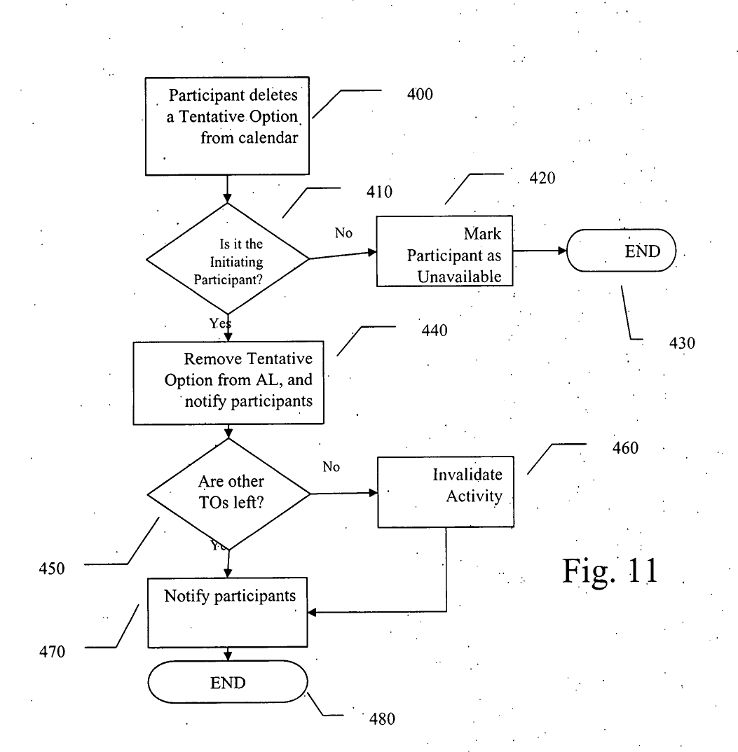

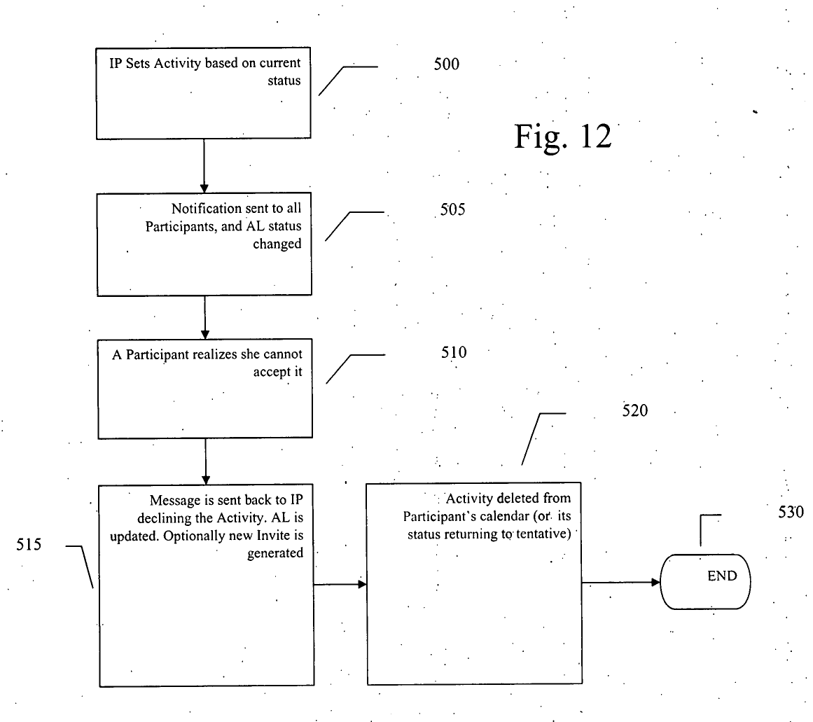

The present embodiments provide for the scheduling of multiple tentative options, meaning that the same activity can be scheduled tentatively several times, to allow for each user to check his best options. Conflicting tentative activities may be set and there is provided a mechanism to automatically cancel all conflicting activities, FIGS. 12, 13 and 14 below. Once the conflicting activities are canceled, one of the remainder is selected as the confirmed activity, and redundant tentative options can be removed, as discussed in FIGS. 10 and 11.

Furthermore, a method is included to optimize the layout of activities within the calendar, by having the initiating user supply preferences such as break preferred between activities, breaks preferred at certain time of day (lunch for example) or account for travel times. The system can be configured to automatically set activities based on the results of a scheduling operation. For example before and after a meeting in a location that requires travel, the calendar should have travel activity entered. This activity should only be added after the activity is set. Before the main activity is fixed, the accompanying activity can likewise be put in as tentative. Another option is that a group of activities have accompanying activities attached, and it is possible to define such groups logically or manually as preferred. For example, certain meetings at a distant location need travel time before and after all the meetings have occurred. The main activity can only be set after all the accompanying activities have been set (or canceled). That is to say, the meeting itself is never confirmed until the travel time before and after has been confirmed. That is simply the digital version of ensuring meeting attendance is not confirmed without knowing whether the attendee has time to travel.

The data accumulated within the system can be further used to maximize activity attendance and minimize communications between potential participants. As the A1 logs acceptance/rejection information from the users it can build a per user profile of behavior. This adaptive profile can then be referenced by an Ip wishing to schedule a meeting with a specific user (or group of users) of the system. The Ip may send a query to the A1 indicating that she wants to schedule a meeting with the specified users and the A1 may reply with a list of proposed tentative options which, according to the history of the users, are more likely to be accepted. The answers from the A1 do not breach the potential invitee's privacy, as it does not tell the Ip that the participant is free at that time, only that there is a higher chance of acceptance at that tentative option. If privacy is still a concern at that point, such a likelihood guessing functionality can be limited to activities with two or more participants, so that the originator cannot tell to whom the reservation applies.

In addition, if the A1 has a view of the originator's calendar, for example as a result of inspection by the smart element, the scheduler may be able to suggest options which in addition to the invitees, do not conflict with the originator's activities. Another option is to have the A1 review a suggested group of tentative options and comment on the chances of having any one of these options accepted based on the historical rejection/acceptances of the participants. The A1 could suggest changing one or more of the tentative options before they are sent to the participants if such is in conflict with the historical behavior. Such analysis and profiling can be done using Bayesian logic, KNN, Support Vector Machines (SVMs), logistic regression, and other machine learning algorithms.

Reference is now made to FIG. 10, which is a simplified flow diagram showing how tentative options are set and the rules under which conflicting tentative options from other activities are subsequently removed as one of the options is confirmed. At some point in time, whether automatically based on a time trigger (e.g. An RSVP deadline) or based on an update in the tentative options states, an originator may decide to set an activity, stage 300. Even if according to the database, all participants are in concurrence with this selected tentative option, due to network latency, race conditions and the peculiarities of computerized networks, a conflict may occur. Therefore, stage 310 checks whether the tentative option is still available. If the option is not available anymore, the processing continues at FIG. 11, as shown in stage 320.

If the time is available on the calendar, but the activity is not placed on the calendar in the form of a tentative option, stage 330, then the activity is added as a set, that is non-tentative, activity in stage 340. If the tentative option is present, its status is changed to confirmed or set in stage 350. In any case, at stage 360 all now redundant tentative options are removed from the calendar. Redundant tentative options are identified by their activity identifier.

As a result of setting the activity, (i.e. converting one tentative option to a confirmed option and finalizing the activity), other tentative options for other activities may now conflict with the newly set activity. These tentative options may be deleted in 370, and the status of the activities in the A1 reflects this.

Step 370 may cause other activities to have no more available tentative options left. Such a predicament is tested in stage 380, and if it is found to be the case then the activity status is changed to reflect the case and a notification is sent to the appropriate initiating participant, following which point processing ends in stage 395. If no activity is affected in this way, then processing ends at the point but without any need to notify anyone.

In some cases, a participant schedules an activity directly into his calendar, and this activity conflicts with tentative options of other activity(ies). A flow for such a scenario is now described with respect to FIG. 4. In FIG. 4, the natural action of the participant may be to directly delete the tentative option from her own calendar, stage 400. If the participant is not the initiating participant as determined in query stage 410, then the only result is an update of the activity status in the A1 and the processing ends at end point 430. If, on the other hand, the tentative option deleted in step 400 is deleted by the Ip, that is the originator, of that activity, then processing continues at 440 where the tentative option is removed, or marked as removed, at the A1, resulting in the option becoming unavailable to all other participants. Now, there is a possibility that no other tentative options are left for the corresponding activity. The possibility is tested in stage 450. If there are other active tentative options, then processing ends at end point 480. If no tentative options remain for that activity, then the activity may be invalidated in stage 460 and participants are notified that the activity has been canceled. It is now up to the originator to create a replacement activity.

As mentioned earlier, due to the time lags involved in computerized networks and network activities, a race condition may occur, in which, for example, an activity is set for an option which was deleted just seconds earlier by a participant, although the deletion information has not propagated yet throughout the system. The present logic minimizes the risk of such an occurrence, but cannot completely eliminate it. Therefore, conflict resolution mechanisms are preferably incorporated as described in FIGS. 12 & 13. Those skilled in the art may notice other potential race conditions, however the processes depicted hereinbelow can be used for those as well, with suitable adaptation.

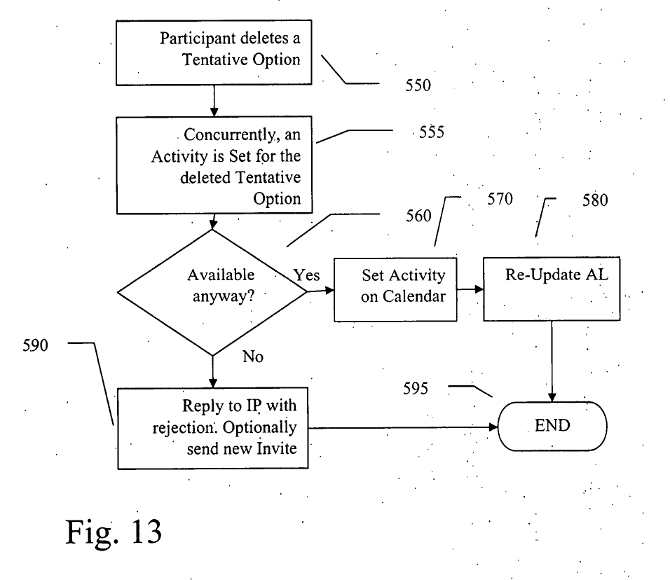

Referring now to FIG. 12, in stage 500 the originator (IP) sets an activity, stage 500. Notifications propagate through the network during stage 505, and the AL is set accordingly. Then, in stage 510 the invitee declines the tentative option set by the IP when the notification arrives, as she realizes she cannot accept the option selected. In this case, a message is sent back to the originator or to the AL at the server, declining the activity and it is up to the originator to decide whether to carry on the activity anyway, or reschedule and reopen other tentative options, stage 515. In any case, that specific activity is either deleted or changed back into tentative in stage 520 based on the selection of the originator. At this stage the conflict is resolved and processing ends 530. In FIG. 13 a similar but alternative scenario is presented in which an invitee deletes a tentative option just as the originator sets it as final. From the participant's view, the processing is similar (550 & 555) to FIG. 12. However, when the notification arrives, an option is provided to the invitee to accept the activity anyway (560), in which case the activity is set on the participant's calendar (570) and the activity status in the A1 is re-updated (580) to reflect the renewed availability of the participant. At that point the processing ends and the conflict is resolved. If the participant is really unavailable in 560, then similarly to 515, in 590 a notification is sent back to the originator with the declination. At this point the originator can decide to hold the activity anyway, or re-send new activity invitations. The processing ends at end point 595 with the conflict resolved either way.

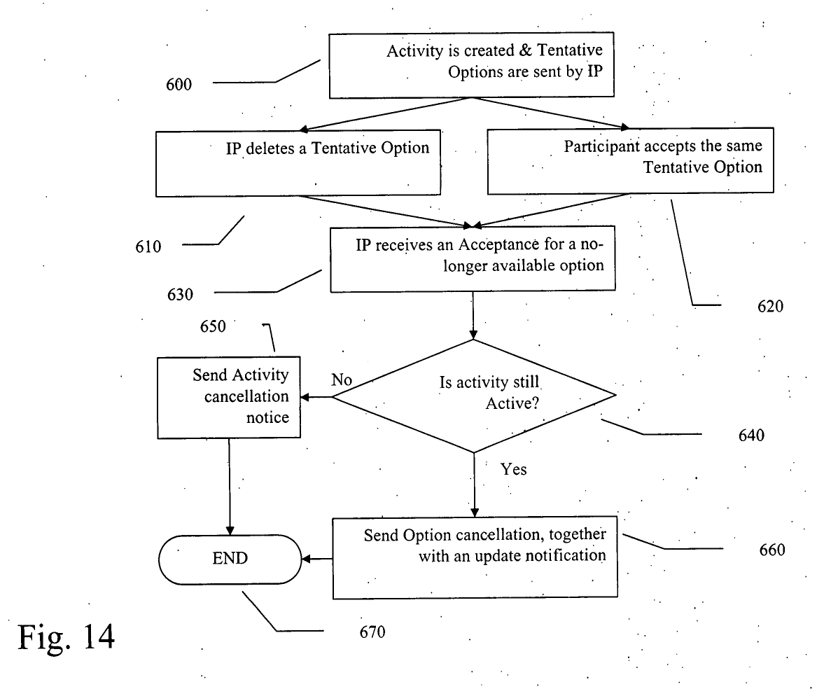

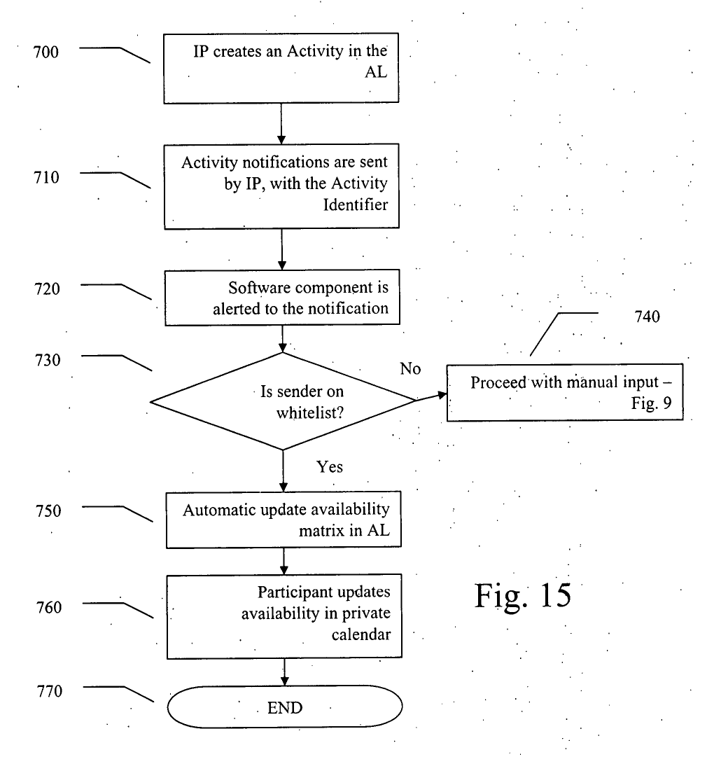

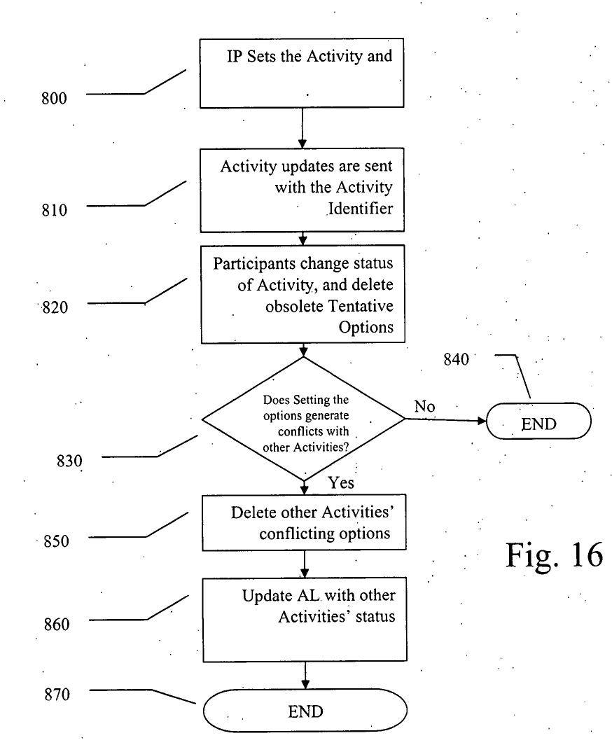

Reference is now made to FIG. 14 which illustrates the case in which the originator deletes the tentative activity as it is being accepted by invitees. As before, an activity is created in stage 600. A tentative option is accepted by a participant in stage 620 at the same time that the option is deleted by the originator in stage 610. The result is that the originator now has an acceptance for a no-longer available tentative option. At this point, if the activity as a whole was deleted or is inactive, as tested in 640, a cancellation notice is sent to the participant in stage 650 and processing ends at end point 670 with the conflict resolved. If the activity, as tested in 640, is still active, then the originator sends a notification of the tentative option cancellation, together with an update notification in stage 660 depicting the other tentative options still available for that activity. At this point the conflict is also resolved and processing ends.

The above-described processing can be automated with very few interaction points. The person skilled in the art will notice automation opportunities in the processes described. An exemplary embodiment is now described.

Reference is now made to FIG. 15, which is a flow chart for an embodiment of the present invention in which automatic processing of invitations is restricted to trusted users. A participant allows others to act as activity originators (IPs) to get automatic acceptance or declination of tentative options as long as they are based on a whitelist of trusted users. This means that only originators on the specific configurable whitelists obtain such a privilege.

As a variation, instead of accepting users on a whitelist, all users could be accepted except for those appearing on a blacklist. Alternatively, users on a whitelist might be handled automatically. Users on no list might be handled semi-automatically, and users on a black list might be handled manually or not at all.

In one embodiment the white list may be built up automatically from the user's address book, and/or the black list may be constructed automatically from the user's junk mailer list.

If the whitelist option is enabled, then when the Ip generates the new activity (stage 700), and notifications are sent to participants (stage 710), then a software component connected to the participant's inbox monitors the notification in stage 720. When a notification is identified, the software tests whether the sender is on the whitelist in stage 730. If not, then processing continues as in FIG. 9 above. If the originator is on the white list, then the software is allowed to access the participant's calendar, and preferences, and can then automatically update the availability table or matrix in the A1 (stage 750). This provides almost immediate feedback to the Ip as regards the availability of the participant, and this is the reason that such a function is preferably protected by a white list. If certain tentative options are unavailable, the software component can delete these options automatically, without further processing in stage 760, at which point processing ends (770).

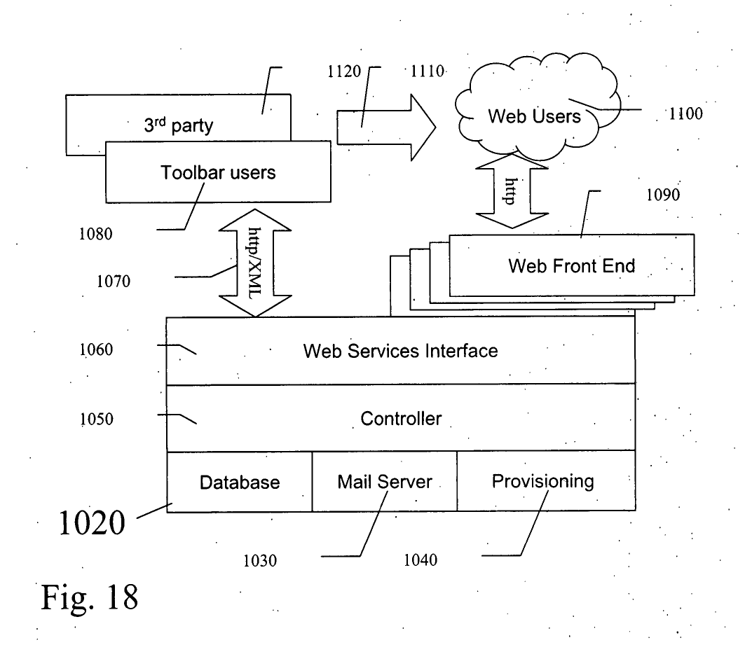

Reference is now made to FIG. 18 which is a simplified flow chart illustrating the removal, not of conflicting but of now obsolete tentative options after the originator, IP, has finalized an activity as being in a particular time slot. The IP sets up the activity as before in stage 800. In this case, notifications are sent to all invitees in stage 810, and the software component changes the status of the activity, sets the selected tentative option as confirmed, and deletes the obsolete tentative options that were associated with this activity in stage 820. However, such a setting of a tentative option may create a confirmed conflict with another activity's tentative options. The occurrence of such a conflict is tested in stage 830. If the result of the test is no, then processing ends there at endpoint 840. If a conflict is identified, then the conflicting tentative options are removed from the calendar (850), and the A1 is updated with the new availability data (860), and endpoint 870 is reached.

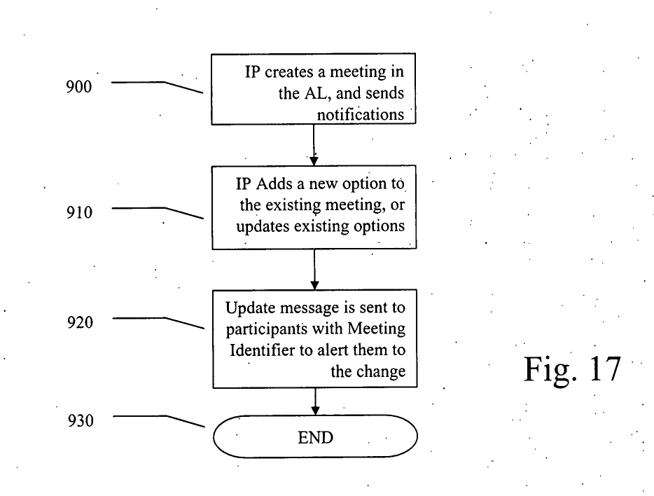

Reference is now made to FIG. 17 which illustrates a scenario in which an originator modifies activities after they were initially created and participants notified. The originator creates an activity in stage 900. Then the originator, in stage 910, decides to add another tentative option to the activity. In this specific case, a stage 920 is incorporated, in which update notifications are sent to the participants, notifying them that a change has occurred in the activity data. At this point, they may choose to check what has changed, and potentially update their selections and preferences. Likewise the scheduler is preferably notified of the changes, as further actions may be necessary. Processing ends at end point 930. Various scenarios follow the logic as depicted in FIG. 17, with modifications which will be clear to the skilled person.

Reference is now made to FIG. 18, which is a simplified diagram illustrating in greater detail the server based embodiment of FIG. 3 above. A controller 1050 implements the server side logic of this invention, using a database 1020 to maintain persistent data such as activity status and context. A mail server (such as sendmail™) is used for web-based users when notifications are to be sent or received. For commercial reasons, a provisioning server may be included 1040 to facilitate charging users, and creating/deleting accounts.

A web services interface 1060, as known in the art, is used to communicate between the back-end services, 1020 to 1050, and the front end components, via the internet. A web front end 1090 may be needed for direct communication with web users. An http link is represented by numerals 1070, 1100, and user interaction occurs through these. The web services interface 1060 may be the Outlook™ email, and calendar. The web services interface may support toolbar users 1080 and users 1120 accessing the system via 3^{rd} party services and resellers.

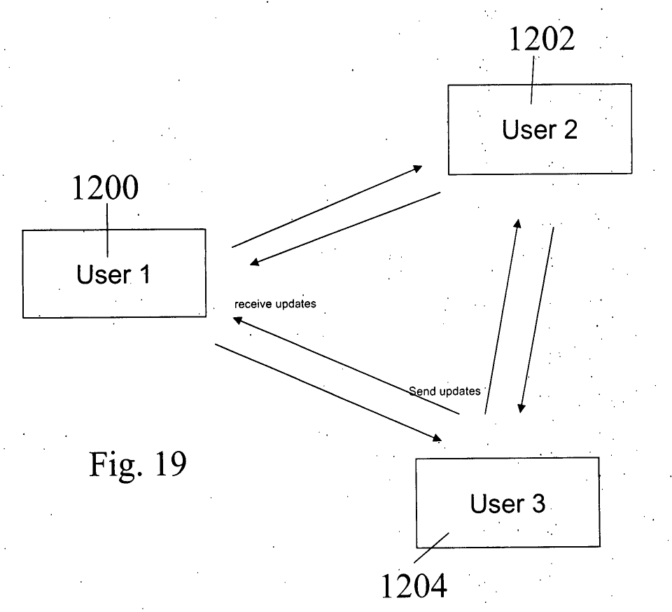

Reference is now made to FIG. 19 which shows in greater detail the peer to peer embodiment of FIG. 5 above. Three users 1200, 1202 and 1204 connect directly with each using peer to peer connections, and send and receive updates.

The peer to peer network model does not assume that all the users are online simultaneously. Instead the model assumes that the request packets are small so that storing them on other nodes of the network is relatively cheap. In another embodiment email is used as the transport.

Since the system is decentralized user 1, 1200, has no way of knowing whether more distant nodes, say 1204, are going to come online. Instead it copies a request it may have received from user 2, 1202, around the network, and the request waits at 1200 and 1202 waiting for 1204 to come online.

Finally 1204 comes online. One copy of the request is sent and for the rest it is necessary to propagate a delete request so that further copies of the request are deleted and do not clutter the network. In one embodiment a request can have a time to live (TTL), in other words an expiration date, to guarantee that if 1204 never comes online the request will eventually get deleted.

As data is being sent over a peer to peer network, the request is preferably encrypted. Standard encryption tools may be used so that intermediate peers on the network cannot read the messages. However an additional issue is that some users may require that such an open network does not know that there exists a request from 1202 to 1204 at all.

For this purpose public-private key encryption such as RSA may be used. Then, to hide information as to who are the originators and intended recipients of the request, the identities of 1202 and 1204 are preferably encrypted using 1204's public key, which is available to 1202. Then each node of the peer to peer network tries to decrypt the identities using their own private keys and compares them to their own identity. Since only 1204 has the correct private key, it is able to decrypt the message to discover its own identity. This hides the real identity of the sender and recipient from the rest of the network while allowing the request to be delivered to 1204.

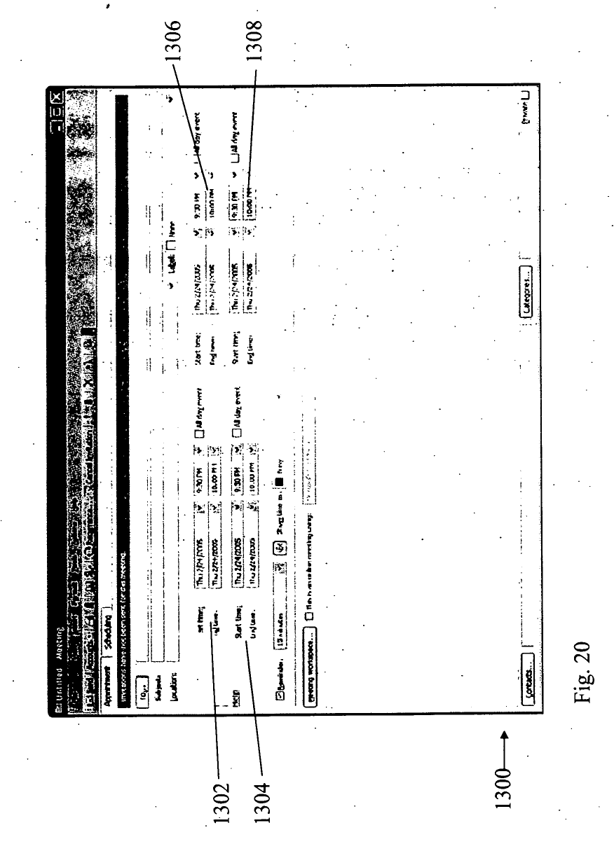

An embodiment of the present invention used with Microsoft Outlook™ is depicted in FIGS. 20 to 28, and the activities are multi-user meetings.

FIG. 20 is a screenshot showing a Microsoft Outlook™ form 1300 enabled for the present embodiments. The form is used by the originator to specify the tentative options such as preferred start and end times and date, the participants' email addresses and other data pertinent to the meeting. As shown four sets of start and end times are provided, 1302, 1304, 1306 and 1308, which allows a multi-option meeting.

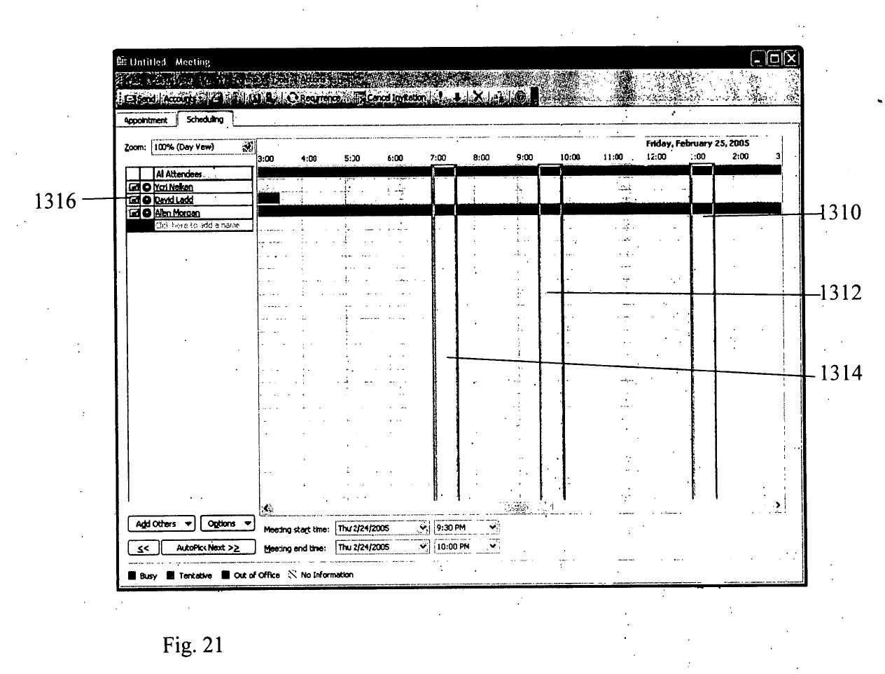

FIG. 21 is a screenshot that shows the second, scheduling, tab of the meeting invitation 1300 enabled with the present embodiments, with the multiple tentative options showing in 1310, 1312 & 1314. The user (participant) list is shown as 1316. In this embodiment participants who are on the same exchange site can see each other's availability, and this information can be used when deciding on the tentative options.

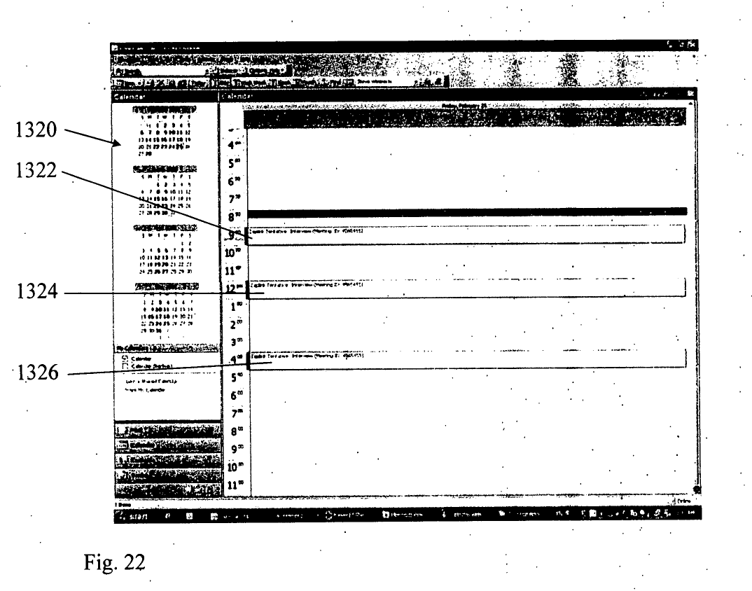

FIG. 22 shows a calendar view 1320 with three tentative options 1322, 1324 & 1326. The tentative options are preferably color coded as Outlook™ tentative meetings.

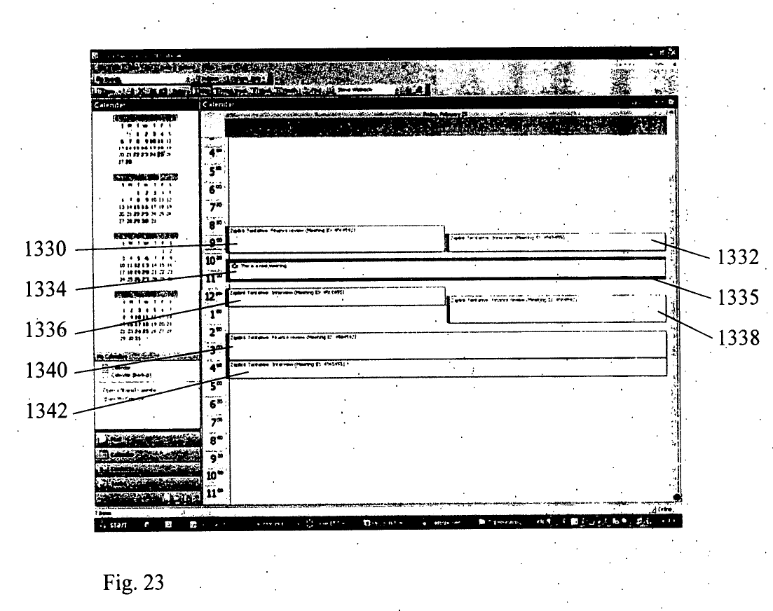

FIG. 23 is again a calendar view, but this time shows a scenario with seven activities 1330, 1332, 1334, 1336, 1338, 1340 and 1342, with multiple activities scheduled, and some tentative options which conflict (e.g. 1330 & 1332). In contrast, meeting 1334 is a standard and already fixed outlook meeting and is color coded differently—note horizontal border 1335, in contrast to the other activities which have vertical borders. If the user now removes outlook meeting 1330, for example, then such an action is reflected in the A1 and meeting 1332 is effectively confirmed. The user is thus marked as unavailable for that time slot. And no further activity is needed on that user's behalf aside from informing him about the other user's availability.

If, on the other hand side, the originator of meeting 1330 sets that tentative option as the final selection, 1330 becomes a confirmed Outlook™ meeting, and the system may automatically delete tentative option 1332 as the user is now unavailable at that slot. The skilled person will appreciate how the rest of the processes described above are expressed using the Outlook calendar. The present embodiment clarifies and implements the “contingent meetings” functionality described above by using dynamic on-line tentative options for activities.

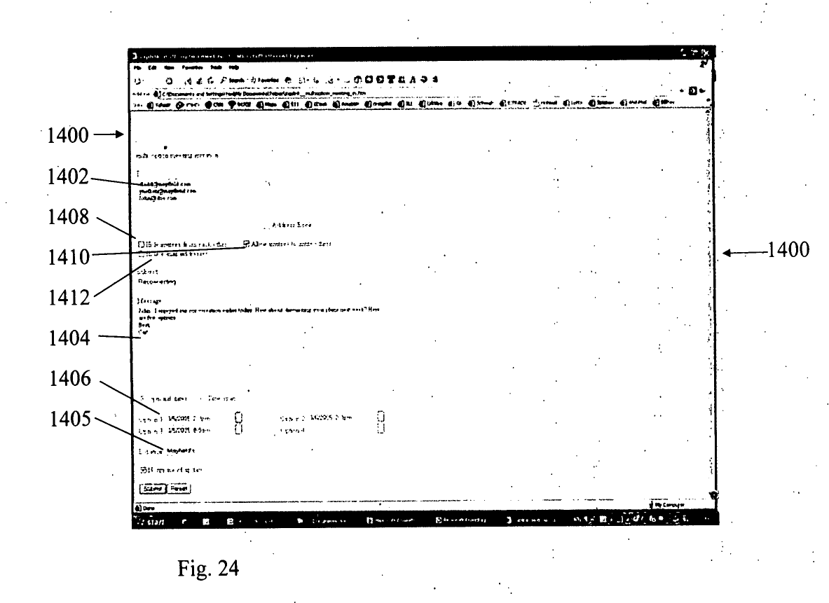

FIG. 24 illustrates an alternative embodiment without integration into Microsoft Outlook™. In the embodiment of FIG. 24 a web based meeting invitation 10 form 1400 allows an activity originator to insert relevant activity information, recipient list 1402, message 1404, location 1405, and multiple date and time options 1406. In addition there may be provided check boxes for e.g. hiding or revealing invitees to each other 1408, allowing invitees to invite others 1410, hiding or showing email addresses 1412. When the submit button is clicked, a tentative meeting is created and notifications are sent from the supporting server, or from the originator in the peer to peer case.

A separate page that lists activities, their current status and a log of changes is also provided. Such a page can be web based or part of the client software. It communicates with the A1 to gather the data to be displayed.

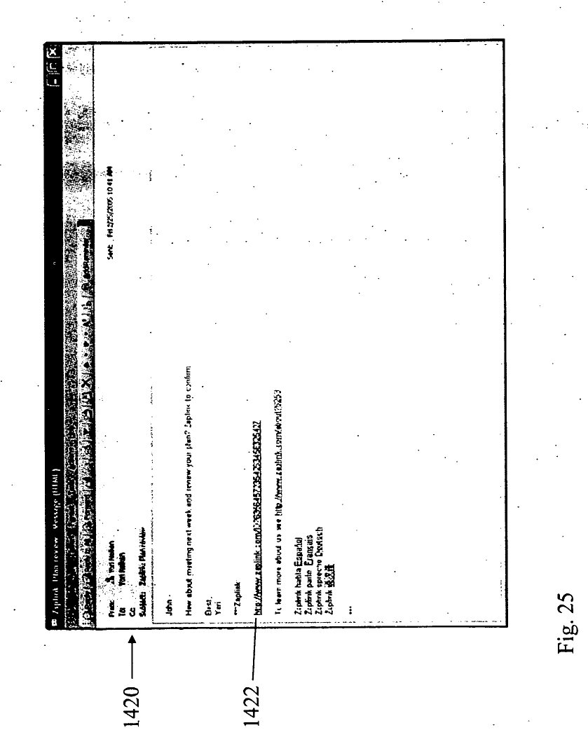

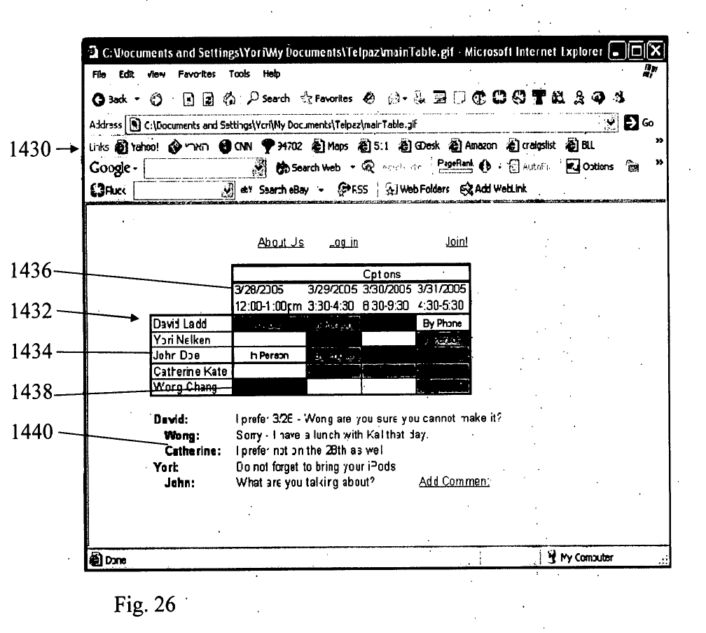

FIG. 25 shows a sample meeting invitation 1420 received with no Outlook™ integration. An activity identifier is embedded in link 1422, and once clicked by the participant, leads to a form which shows meeting details and which is shown in FIG. 26 below. The recipient is not required to log in or subscribe to the service.

Referring now to FIG. 26, and form 1430 represents the meeting as an availability matrix 1432. The availability matrix is here displayed with the participants 1434 in rows and the tentative options 1436 in columns. Cells 1438 show the current state as per that user and that time slot. Color coding can be used to distinguish between “available”, “maybe”, “unavailable”, or “no data”. An easily understood scheme is the traffic light colors, green, yellow, and red, with white for no data. A message board region 1440 is allowed for users to leave comments, and thus provide a collaborative scheduling effect.

Additional data about the meeting can be displayed, for example the mode of acceptance (e.g. by phone, in person etc). The embodiments thus support multi-modal scheduling.

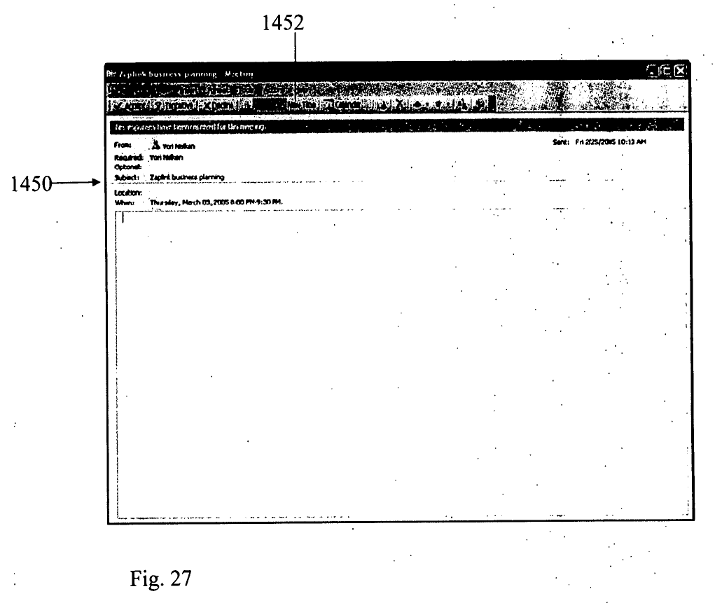

FIG. 27 shows a standard outlook™ invite form 1450 as might be received by an invitee who is enabled with this invention. The user can still use the standard outlook functionality, however a new button 1452 allows the user to return to the sender and offer tentative options.

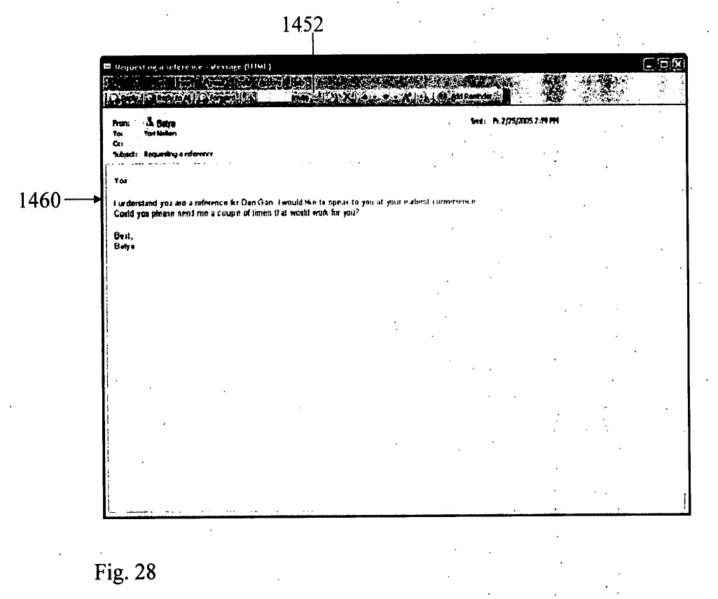

Reference is now made to FIG. 28 which shows how the time selection button 1452 can be integrated into a typical email 1460, useful for example when the email is an invitation to someone else to set up a meeting.

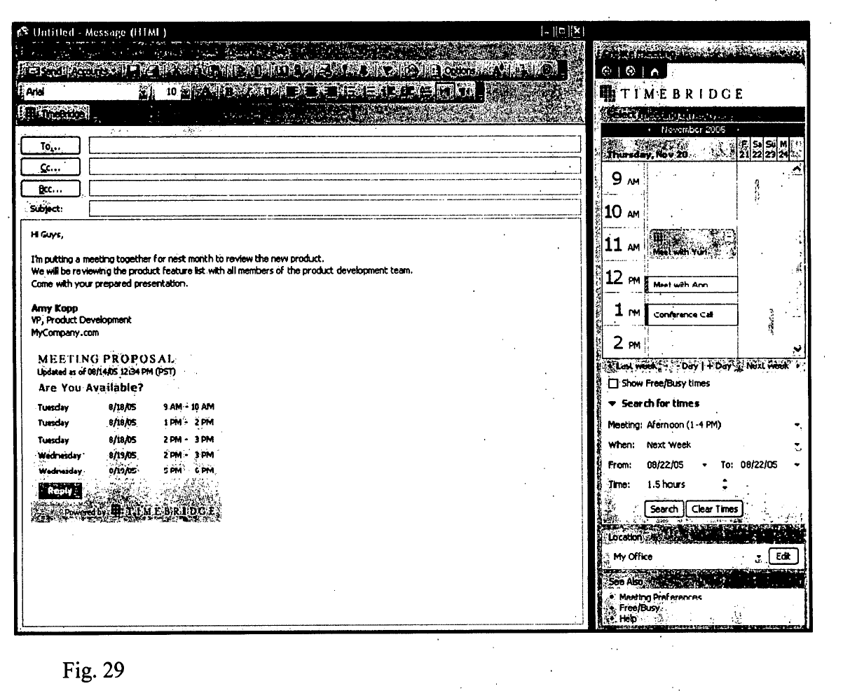

FIG. 29 shows an alternative way of presenting the alternative time slots for a meeting.

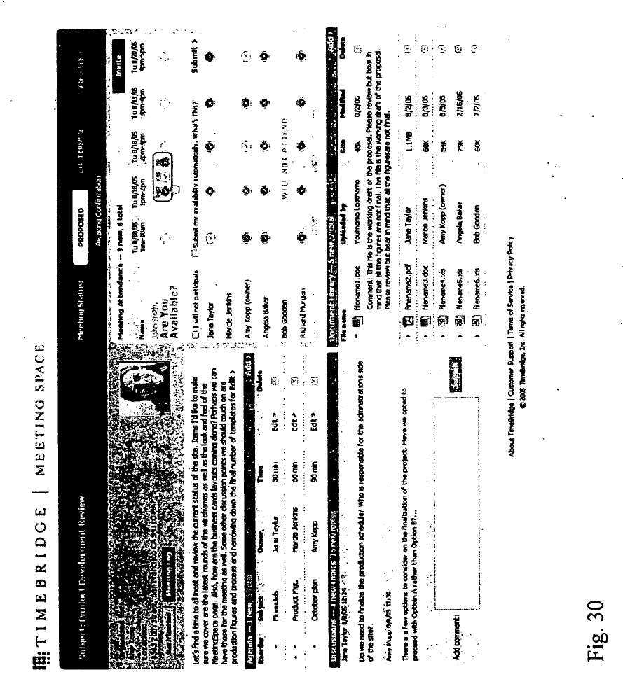

FIG. 30 is a screen shot of a window showing how the screen of a meeting organizer might appear for the meeting of FIG. 29.

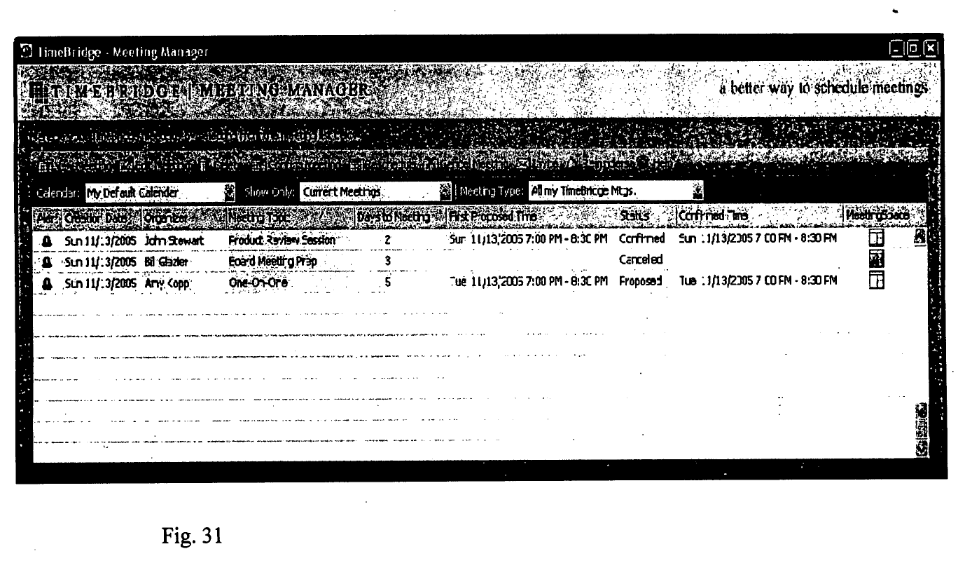

FIG. 31 is a screen shot showing a list of current meetings of a user according to a preferred embodiment of the present invention. Meetings are shown with topic, organizer, proposed times, confirmed time if any and status. The screen of FIG. 31 is an alternative to showing the meetings on the calendar as in previous figures.

In an embodiment there is provided a persistent calendar window that appears within an email without needing to switch screen between the email and the calendar. The screen can be shown on an outbound message as it is being constructed by the user, as well as on an arriving message. In an embodiment the calendar window may be turned on or off with a single click.

The calendar window within the email preferably uses a two-click navigation scheme to get to any given day, via separate month grids and day grids. Voting options can be provided by selecting a time in the day portion of the window and then clicking enter or otherwise confirming the selection. In this way the selection is made graphically, however the details of the selection could in fact appear as text in the email.

In an inbound email according to a preferred embodiment it is possible to select time data from the message text so as to automatically scroll the calendar view to the same time. Thus text selection leads to graphic selections.

In another embodiment, there is no initiating participant as such. Rather there is an organizer who has overall control of the activity, but does not necessarily participate. Obvious modifications to the above description will stem from such a configuration, and it is part of this invention. For example, as the organizer does not actually take part, tentative options need not be erased in the event of a conflict at the organizer.

In another variation, some or all of the participants may be granted similar rights to the originator, for example adding other participants or suggesting additional tentative options. Such would be useful for example where the originator is subordinate to someone else.

In another included variation, recurring meetings can be set and stored in the A1, with reminders or notifications sent at pre-set times to gather attendance statistics prior to an occurrence.

In another variation of the present invention, the originator is detailed to create multiple meetings within a specific time span for the same participants, for example meet three times this week.

In another variation some of the invitees have administrative assistants who manage their calendars, and the administrative assistants are given access to the system in order to complete the scheduling.

Internet text messaging, or contacting using mobile interfaces such as WAP and SMS through mobile devices are all within the scope of this invention.

Meeting logs and change logs may be generated and the logs can be integrated into enterprise systems such as CRM systems.

In the following are discussed issues of trust networks and elements of calendar and information exchange relationship levels.

Several layers of information sharing can ease the scheduling burden and reduce the time and pain associated with the current process of scheduling a meeting. Trust network relationships are peer to peer based—i.e. they require that a member be connected to the internet and the service in order for them to work.

Autorespond to Meeting Requests

One of the biggest problems associated with finding out availability for potential meeting attendees is the delay between sending a message asking about availability, and the recipient seeing the message and responding with an answer. The preferred embodiments thus begin with a response referred to as autorespond. An autorespond relationship means that the service automatically responds on your behalf with your scheduled availability when a request is made of you by a member of your trust network. The service responds to say whether you are free or busy for any proposed meeting. It will not accept a meeting, but it will indicate availability.

In general, trust network relationships work in one direction only. Using the autorespond feature as an example, if member “b” adds member a to their trust network, any meeting request sent by a to b will generate an auto-response. A meeting request created by b and sent to a will not generate an auto-response, unless member a also adds member b to their trusted network.

Free-Busy

A free/busy trusted network relationship will allow a member access to another member's free/busy information. This could take the form of either an ability to see free/busy information while searching for specific available meeting times, or could also take the more general form of full access to see another person's free and busy times on a calendar. The key element of free/busy which makes it more valuable, and potentially more of a concern to those with issues about security, is that free/busy can be seen without issuing a formal meeting proposal.

Calendar Publishing

A member may need to share specific and often very detailed information about their calendar and/or availability over a discrete range of time to important people, but not want these same people to have permanent ability to query his calendar. This can range from a day to a series of days, or even a permanent and perpetual publishing of ones calendar to selected key people, for example spouse, children, administrators. Querying can be for free/busy or full calendar details. The scheduler of the present embodiment may allow members to publish calendar information to others, irrespective of whether they implement the scheduler or not, for any time range via the web, email, or phone/SMS/mobile. Publishing can be done on either a perpetual basis, or on a subscription basis (daily, weekly), or for one time only. Furthermore, the present embodiments allow a member A to see all the occasions when member B looked at A's calendar. By being open about when the calendar is viewed, privacy issues may be reduced and the existence of the option also may serve as a reminder to A that B can look at her calendar.

Inheritance of a Central Calendar Server such as Microsoft Exchange™ Sharing Features

The present embodiments fully inherit all the available information sharing opportunities from the a central server, if exists, where it is available to a member. For example, the service is able to search all the server's free/busy information when in search mode for available times. It is also able to list free/busy information in manual selection mode for invited attendees. So, using the presently preferred embodiments, a member will be able to do full free/busy searches on any person (member or not) in their company on the same central server.

Creating, Managing and Building a Trust Network

There are three basic approaches to adding people to a trust network.

1) Contextual—the first model is the contextual model—where you add someone within the context of a meeting transaction you are conducting. An example of the contextual model would be selecting the ‘auto respond’ check box in a response to a meeting request. This is a low profile way to begin to establish the trust network and offer a base level of sharing between people who are already engaged in meeting transactions. For the autorespond and also the free/busy relationship level, the present embodiments may build contextual and viral opportunities to add new trust network relationships via meeting requests and service notifications.

2) System level—the second way to add people to a trust network is via a ‘trust network’ application screen. In the Outlook™ toolbar as modified by the present embodiments a trust network button displays an application screen which shows a current trust network. It will be appreciated that the present embodiments are not limited to Outlook™ or any other specific client. The application screen lists members names, their email address, the level of the sharing relationship, and data related to the usage of the trust relationship (for example, information such as the number of times they have used the trust function and the most recent use). A user can add new people to the trust network either individually or as part of a larger group. It is necessary simply add the email address and define the type of trust relationship of the person one requires to add to the trust network. The person being added preferably receives a notification that they have been added to the network.

3) Group level—A third way to add people to a trust network is via a group feature. A group can be defined and easily added to a trust network, thereby automating the process.

The value of a scheduler according to the present embodiments to any individual user thus increases over time as the size of their trust network grows, provided that they use the system. Therefore, viral elements are preferably built into the service to encourage members to grow their network as soon and as large as possible. An initial “build your network” screen might be presented when a member first joins the service that could enable a member to add several people to their trust network at a single time, by an offer to scan your calendar and/or email and determine whom you communicate and meet with most frequently, and propose that you add these people to your trust network. Alternatively the scheduler may offer to scan one's contacts and see who is already a member, and ask to consider adding such users to one's trust network.

In one embodiment a member can be provided with the ability to suspend their entire trust network or any part of it for any time period, or indefinitely. The feature may be implemented via a simple check box on the main trust network application screen. The feature would address sensitive periods when calendar and/or meeting information should not be available to others.

Trust Network Groups

The service preferably allows a user to add new groups to the service and establish trust relationships between each member of the group and the others. For example, if a new virtual project team is established, and they all need to begin scheduling meetings, it should be simple for one person to add the email addresses of all members of the group. Each member of the group receives an email asking them to approve the formation of the group. Once approved, each person becomes a member by downloading the software (unless they are already a member), and then the system automatically adds each of the other members of the group to their trust network. The scheduler service may then generate an automated service notification requesting each member of the group to approve, and once approved all members are part of their respective trust networks and are added to the group on the local computer. The above feature avoids the situation where there are x people in a group, and all of these x people must add (x-1) individuals by name to their trust network. The group feature reduces the work involved so that only one person actually has to type in the group details, and then each member simply clicks to approve the request. After the initial group has been established, additional members should be able to be easily added.

In one embodiment, organizations may be allowed by members to add meetings to their schedule. For example a corporate entertainment event, such as a game, or a show can be added to the schedules of every person in the company. A selection process in which users select organizations would allow members to control what types of events they receive meetings for. At any point, as usual, if the member decides to, he can remove the organization from his trust network. Also, the member can decide that the meetings set up by the organization are never more than tentative.

As mentioned above, for certain meetings, invitation recipients can be given a certain level of organizer power, and will thus be able to invite more people to the event.

A scheduler according to the present embodiments could also serve as a portal to event oriented organizations, collecting the members' favorite events and intelligently suggesting more. The member can thus be exposed to the options of events that are not related directly to other commercial companies but may simply be of interest to the member. Examples include open lectures, fireworks, lunar/solar eclipses, critical masses, demonstrations, etc. The scheduler may use a personalized profile per each member in which the member what they are interested in and how relevant they should be before a meeting invitation is sent out. The member can also specify how much time in advance he wants to get the invitation. After all, eclipse dates are known for the next several centuries. The profile can include dynamic learning, and by accepting or declining a meeting the member can give the system valuable information about their preferences.

An advantage of having the scheduler serve as an event portal is to increase its viral capacity. As events of general interest are supplied, people might wish to connect initially, even if no-body that they know is connected.

It is expected that during the life of this patent many relevant devices and systems will be developed and the scope of the terms herein, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A scheduler for scheduling activities amongst networked users having on-line calendar information, the scheduler comprising:
a network mobile element directable over said network to invitees, said invitees being ones of said networked users invited to a given activity by another networked user being an activity originator, said network mobile element being configured to automatically cause gathering of availability data from respective on-line calendar information of said invitees, and
a scheduling element for collating said gathered availability data, thereby to schedule said given activity at a time of high overall availability amongst said invitees.

2. The scheduler of claim 1, further configured to retain active links with said respective on-line calendar information, thereby to allow dynamic updating.

3. The scheduler of claim 1, further configured to allow invitees to delegate responding to scheduling to a third party, said third party having access to their on-line calendar information.

4. The scheduler of claim 1, wherein said scheduling element comprises an electronic invitation unit configured to automatically issue electronic invitations to said invitees, indicating said time of high overall availability.

5. The scheduler of claim 3, wherein said electronic invitations comprise a refusal option for selection by an invitee, the scheduling element being configured to reschedule said activity in the event of a refusal option being realized.

6. The scheduler of claim 5, further configured to classify invitees so that said rescheduling is only carried out in the event of a refusal option by an invitee from a predetermined classification.

7. The scheduler of claim 1, wherein said network mobile element comprises an encryption unit configured to encrypt said gathered availability data prior to transfer over said network.

8. The scheduler of claim 1, wherein said network mobile element is configured for reading availability data.

9. The scheduler of claim 1, wherein said scheduling element comprises a tentative reservation unit configured to pass at least one tentative time slot to said smart element, said network mobile element being configured to reserve said at least one tentative timeslot in said on-line calendar information of said invitees for subsequent confirmation by an invitation.

10. The scheduler of claim 9, wherein said network mobile element is further configured to reserve a plurality of tentative timeslots and said scheduling element is configured to obtain preferences of invitees and said originator among said plurality of tentative timeslots, thereby to select an overall preferred timeslot.

11. The scheduler of claim 10, wherein -said scheduling element is configured to view a rejection by said originator as a cancellation of a tentative timeslot.

12. The scheduler of claim 10, wherein said scheduling element comprises an update element configured to update invitees and said originator about respectively obtained preferences.

13. The scheduler of claim 10, further configured to cancel a given timeslot from all invitees when rejected by a responding invitee.

14. The scheduler of claim 10, further configured to allow two contemporaneous timeslots to coexist tentatively and to cancel one of said contemporaneous timeslots when the second is selected.

15. The scheduler of claim 1, in a client server configuration for remote activation by clients.

16. The scheduler of claim 1, located at said originator and configured for direct peer to peer contact with said invitees.

17. The scheduler of claim 1, located at said originator and configured for contact with said invitees via a peer to peer network.

18. The scheduler of claim 1, located at said originator and configured to provide each invitee with a list of addresses of other invitees and said originator, such that each invitee is enabled to update all other invitees and said originator, thereby to ensure that all parties to said given activity are updated.

19. The scheduler of claim 18, wherein said addresses are email addresses and said updating is by email.

20. The scheduler of claim 1, configured to react only to activities organized by a user appearing on a list of trusted users.

21. The scheduler of claim 1, further comprising a facility for informing a user about respective on-line scheduling information having been viewed by another party.

22. The scheduler of claim 1, further configured to allow invitees to be categorized, thereby to allow said activity to be optimized around more important ones of said invitees.

23. The scheduler of claim 1, further configured to allow activities to be categorized, thereby to allow said -a more important activity to be given scheduling preference over a less important activity.

24. The scheduler of claim 1, further configured to allow an initial meeting invitation to suggest a range of time slots.

25. A scheduler for coordinating activities between users having on-line calendar information available to a network, the scheduler comprising an autonomous element configured to transfer itself over said network between said users to interact with online calendar information of respective users, thereby to coordinate activities.

26. The scheduler of claim 25, wherein said interacting comprises reading information in said respective calendars in order to find mutually free time and writing in said calendars in order to reserve time.

27. An automated method of scheduling activities between users having on-line calendar information available to a network, comprising:
electronically reading respective on-line calendar information across said network, said respective calendar information being of a plurality of users intended for a planned activity, thereby to find times of mutual availability, and
electronically writing to respective on-line calendar information across said network to reserve at least one time slot for said planned activity at respective intended users.

28. The automated method of claim 27, further comprising maintaining links to said respective on-line calendar information to share updates thereto.

29. The method of claim 27, wherein said activity is initiated by an originating user, said initiating comprising selecting at least a duration, and a list of users intended as invitees.

30. Electronic mailing system comprising:
a) an email client; and
b) a scheduling function associated with said email client for inserting into emails functionality for carrying out automatic scheduling of activities via a plurality of proposed time slots.

31. The electronic mailing system of claim 30, further comprising a common interaction space for users to respond to said automatic scheduling.

32. The electronic mailing system of claim 30, further comprising a calendar carrying activity scheduling data, and a triggering function for triggering activity at said email client when information on said calendar changes.

33. The electronic mailing system of claim 32, further comprising a graphic interface for transferring time slots from said calendar to a meeting invitation.

34. The electronic mailing system of claim 30, wherein information is marshaled onto a meeting invitation using a plurality of kinds of data input.

35. The electronic mailing system of claim 30, wherein said scheduling function is further configured to discover scheduling information from text in an email, thereby to automatically schedule an activity.
